(19) United States
(12) Patent Application Publication
(10) Pub. No.: US 2015/0093487 A1
(43) Pub. Date: Apr. 2, 2015

(54) HEATING PAD ASSEMBLY FOR CONTAINER WARMING

(71) Applicant: Marna June LAWS, Calgary (CA)

(72) Inventor: Marna June LAWS, Calgary (CA)

(21) Appl. No.: 14/040,285

(22) Filed: Sep. 27, 2013

(51) Int. Cl. A47J 36/24; A23L 1/01; A47J 36/28

(52) U.S. Cl. CPC A47J 36/2483; A47J 36/28; A23L 1/01
USPC 426/520; 99/483

(57) ABSTRACT

Disclosed herein are heating pad assemblies for a food serving container, wherein the assemblies comprise a heating pad and a pouch configured to hold the heating pad. Also disclosed are methods for warming a food serving container comprising steps of obtaining a heating pad; heating the heating pad; placing the warm heating pad in a pouch to obtain a heating pad assembly; and placing the heating pad assembly under the container.

### FIELD OF THE INVENTION

The present invention is in the field of a container warmer assembly and in particular relates to an air activated container warmer assembly for food serving containers.

### BACKGROUND OF THE DISCLOSURE

There are numerous apparatuses available in the market to keep food warm. Most of these apparatuses are solely made to keep bulk quantity of food hot/warm after cooking and before serving. In most instances, especially during winter, food once served on a plate becomes cold before one finishes eating it. There is no easy to use and inexpensive dinner plate warmers that can keep the food served on plates warm.

### SUMMARY OF THE INVENTION

Disclosed herein are heating pad assemblies for a food serving container, wherein the assemblies comprise a heating pad and a pouch configured to hold the heating pad. Also disclosed are methods for warming a food serving container comprising steps of obtaining a heating pad; heating the heating pad; placing the warm heating pad in a pouch to obtain a heating pad assembly; and placing the heating pad assembly under the container.

### BRIEF DESCRIPTION OF THE DRAWINGS

FIG. 1 illustrates the components of the heating pad assembly according to one embodiment of the invention.

FIG. 2A illustrates the heating pad according to one embodiment of the invention, while FIG. 2B illustrates the heating pad according to another embodiment of the invention.

FIG. 3 illustrates the pouch according to one embodiment of the invention.

FIG. 4 illustrates an embodiment wherein the heating pad assembly is placed on the bottom of a plate according to one embodiment of the invention.

### DETAILED DESCRIPTION OF THE EMBODIMENTS

Disclosed herein is a device for warming a plate of food, and keeping the food on the plate warm for an extended period of time. The disclosed device comprises two components, a heating pad and a pouch. The heating pad is warmed, either by exposure to air, or by being plugged into a source of electricity, or by other means of warming, and then the heating pad is inserted into the pouch. The disclosed warming device is then placed under the plate, where the heat of the heating pad is conducted to the plate, thereby warming, or keeping warm, the food on the plate.

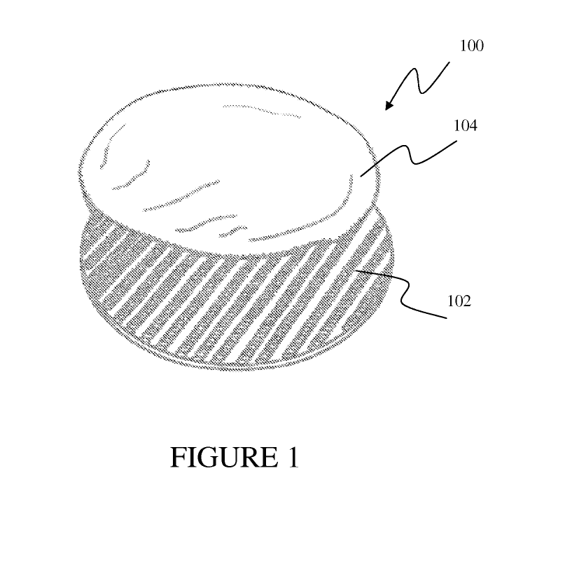

FIG. 1 illustrates the components of one embodiment of the disclosed plate warming device 100. The assembly 100 includes a heating pad 102 and a pouch 104. The heating pad 102, once heated as discussed below, is placed inside of the pouch 104 before use.

In some embodiments, the heating pad 102 is heated chemically. In these embodiments, the heating pad 102 comprises ingredients, such as 1) iron powder, salt and activated carbon; or 2) magnesium sulfate and water; or 3) a supersaturated solution of sodium acetate; or 4) any other set of chemical compounds that cause an exothermic reaction. The activated carbon may be charcoal, which helps in evenly distributing heat on the heating pad 102. In some embodiments, when the heating pad 102 is exposed to air, the ingredients in the heating pad 102 react with the oxygen in the air to cause an exothermic reaction which releases heat energy. This reaction is similar to the reaction that takes place in instant heat packs used in first aid kits or as glove or boot warmers for skiers.

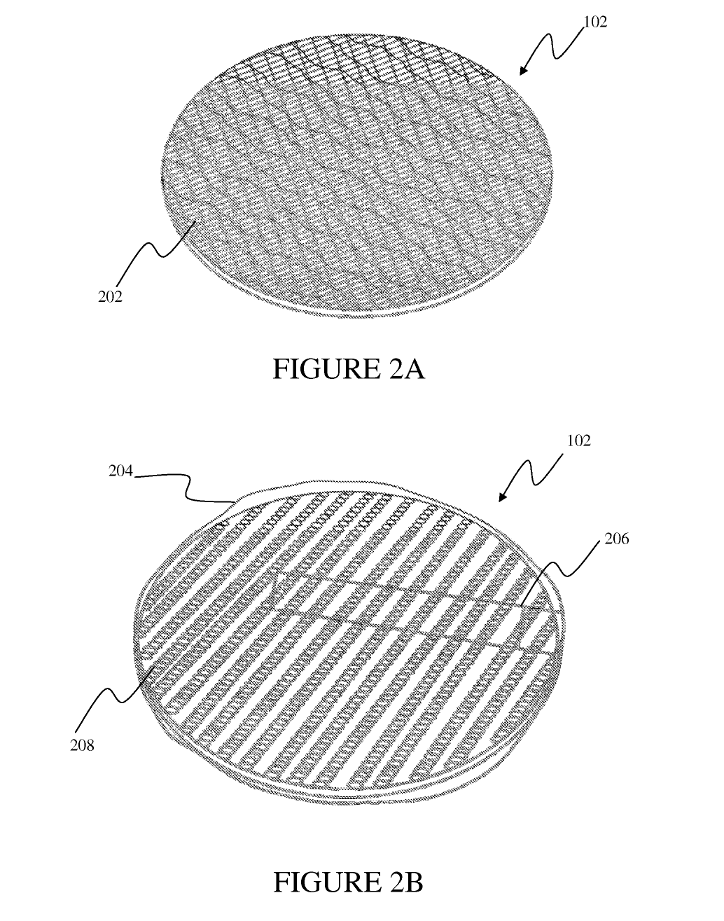

In the air activated embodiments, before the use, the ingredients are exposed to air and the reaction takes place. This happens, for example, when the ingredients are the iron/salt/carbon set of ingredients. In other embodiments, the heating pad 102 comprises small containers 208 (FIG. 2B) of one ingredient, for example magnesium sulfate. The user causes the containers 208 to break and the ingredient come into contact with another ingredient, for example air or water, and cause the exothermic reaction to take place. In other embodiments, for example when the supersaturated solution of sodium acetate is used, the user causes the nucleation of the crystallization reaction. In some embodiments, the reaction is reversible and the heating pad 102 can be used repeatedly. In other embodiments, the reaction is irreversible, and the heating pad 102 is disposable.

In some embodiments, the heating pad 102 comprises at least one compartment 202, and in some embodiments, a plurality of compartments 208, which contain the chemicals.

The duration for which the heating pad 102 releases heat energy depends upon the amount of ingredients in the compartments, the rate of the exothermic reaction, and the amount of energy released, i.e., the AG of the exothermic reaction. In some embodiments, the heating pad 102 releases heat energy for about 30 minutes, or about 20 minutes, or about 40 minutes. The maximum temperature of the heated heating pad 102 ranges from about 50° C. to about 150° C.

Throughout the present disclosure the term “about” a certain value means that a range of value±10%, and preferably a range of value±5%, is contemplated. Thus, for example, about 50° C. includes temperatures in the range of 45° C. to 55° C.

In other embodiments, the heating pad 102 is heated electrically. In these embodiments, the user first plugs the heating pad 102 in a source of electricity, either a wall plug or a battery operated system. The heating pad 102 comprises heating coils 202 (FIG. 2A) that heat up when the electrical current flows through them. The heating pad 102 is then warmed to the desired temperature before use. In some of the embodiments, the heating pad 102 comprises an alert mechanism, such as an led light, or a color strip, that notifies the user when the desired temperature has reached.

In some embodiments, for example the one shown in FIG. 2B, the heating pad 102 is contained within a covering 204. In some embodiments, the covering 204 is removed in order to activate the heating pad 102, which generates heat in response to exposure to air. In some embodiments, the covering 204 is made up of plastic to avoid the exposure of the heating pad 102 to air when the heating pad is not being used.

In some embodiments, the covering 204 comprises a sealable opening 206. In these embodiments, the opening 206 is opened to expose the heating pad 108 to air. Once the device is no longer needed, the opening 206 is resealed and the heating pad 102 is no longer exposed to air.

In the embodiment shown in FIG. 2, the covering 204 is a transparent, soft plastic covering. In other embodiments, the covering 204 is a rigid covering, while in certain embodiments, the covering 204 is opaque.

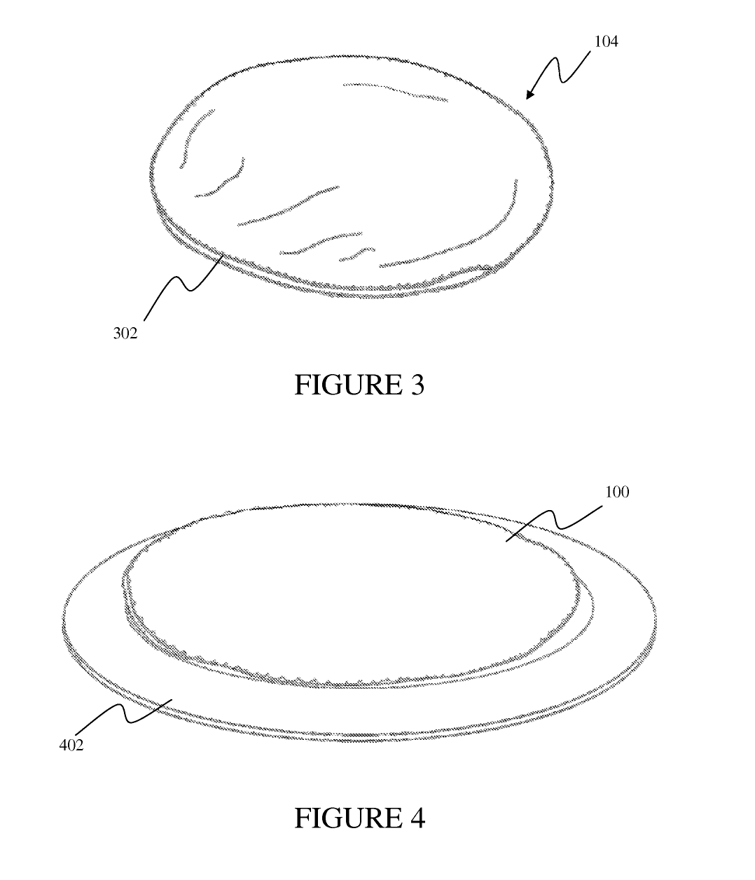

The assembly 100 also includes a pouch 104 configured to hold the heating pad 108. FIG. 3 shows an embodiment of pouch 104. The pouch 104 has an opening 302 around its perimeter to allow the heating pad 102 to be inserted inside of the pouch 104. In some embodiments, the opening 302 is a semicircle. In other embodiments, the opening 302 is an arc larger than a semicircle.

In some embodiments, the pouch 104 has snaps along the opening 302 that allow it closed to enclose the heating pad 102. In other embodiments, the opening 302 closes by a friction lock mechanism. In other embodiments, the opening 302 comprises a zipper or a Velcro® fastener to close the opening 302. In certain embodiments, the opening 302 is not closed after the heating pad 102 is inserted.

In some embodiments, the heating pad 102 has a topside and an underside. When the heating pad 102 is placed inside of the pouch 104 and the device 100 is placed under a plate, then the topside of the heating pad 102 is in proximity with the plate and the underside of the heating pad 102 is on the side opposite from the plate.

In certain embodiments, the topside of the heating pad 102 comprises material that holds the heat and then releases it to the plate. In some embodiments, the material is a metallic foil, for example aluminum foil.

In some embodiments, the underside of the heating pad 102 comprises a heat insulating material, which prevents the heat from the heating pad 102 to be lost through the underside. The insulating material directs the heat to the topside of the heating pad 102, thereby maximizing the heat for use to warm up the dish.

In some embodiments, the pouch 104 comprises a topside and an underside. When the device 100 is placed under a plate, then the topside of the pouch 104 is in proximity with the plate and the underside of the pouch 104 is on the side opposite from the plate. In some of these embodiments, the topside of the pouch 104 comprises an adhesive portion that allows for the pouch 104, and therefore the device 100, to adhere to the plate. The adhesion prevents the device 100 from slipping from under the plate. In some of these embodiments, the topside of the pouch 104 comprises a removable cover. Once the user removes the cover, the adhesive portion is exposed and can be caused to adhere to the plate. The removal of the cover from the adhesive portion is akin to the removal of the backside of a mailing label to expose the adhesive. In some embodiments, the adhesive is of sufficient strength, i.e., causes a bonding between the device 100 and the plate of sufficient strength, that prevents the device 100 from slipping from under the plate, but is not too strong such that the device 100 cannot be removed from the plate with relative ease. Thus, once the user is no longer in need of the device 100, the user can remove the device 100 by exertion of small amount of force, and with relative ease.

FIG. 4 shows one embodiment of the device 100 in use. The device 100 is placed under the plate 402, which is shown in an upside down configuration in FIG. 4. In some embodiments, the device 100 is placed under the plate 402 on the table and the plate 402 rests on top of the device 100. In other embodiments, the device 100 is placed under the plate 402 while the user holds the device and the plate 402 in the user's hand, for example for when the user is standing or walking around while eating.

Thus, in some embodiments, the size of the device 100 is such that when placed under a plate 402, it does not affect the stability of the plate 402 on the table. In some embodiments, the thickness of the device 100 is about 0.25 inch. In other embodiments, the thickness of the device 100 is less than about 0.25 inch, while in other embodiments, the thickness is between about 0.25 and about 1 inch.

In some embodiments, the pouch 104 comprises multiple heating pads 102. In other embodiments, a single heating pad 102 is contained in each pouch 104.

Also disclosed herein are methods of warming a food serving container. The methods comprise the steps of obtaining a heating pad 102; heating the heating pad 102 by exposing the heating pad 102 to air (chemical warming) or plugging the heating pad 102 in electricity (electrical warming); placing the warm heating pad 102 in a pouch 104 to obtain a device 100; and placing the device 100 under a container to be warmed.

What is claimed is:

1. A heating pad assembly for a food serving container, wherein the assembly comprises a heating pad and a pouch configured to hold the heating pad.

2. The heating pad assembly of claim 1, wherein the heating pad comprises chemicals that react with air to generate heat.

3. The heating pad assembly of claim 1, wherein the heating pad comprises heating filaments that generate heat when the heating pad is connected to electricity.

4. The heating pad assembly of claim 1, wherein a first side of the heating pad comprises a heat insulating material.

5. The heating pad assembly of claim 1, wherein a second side of the heating pad comprises a heat conducting material.

6. The heating pad assembly of claim 1, wherein the pouch comprises an opening through which the heating pad is inserted inside of the pouch, and wherein the opening has at least one fastening member to close the opening.

7. The heating pad assembly of claim 1, wherein the heating pad assembly has a thickness of less than 0.25 inch.

8. A method for warming a food serving container comprising steps of :
obtaining a heating pad;
heating the heating pad;
placing the warm heating pad in a pouch to obtain a heating pad assembly; and
placing the heating pad assembly under the container.

9. The method of claim 8, wherein the heating pad is heated by exposing the heating pad to air.

10. The method of claim 8, wherein the heating pad is heated by connecting the heating pad to a source of electricity.

11. The method of claim 8, wherein a first side of the heating pad comprises a heat insulating material, and wherein the first side is placed away from the container.

12. The method of claim 8, wherein a second side of the heating pad comprises a heat conducting material, and wherein the second side is placed in proximity to the container.
